(19) United States
(12) Patent Application Publication
(10) Pub. No.: US 2026/0225235 A1
(43) Pub. Date: Aug. 6, 2026

(54) APPARATUS AND METHOD FOR CONTROLLING ROBOT

(71) Applicants: Hyundai Motor Company, Seoul (KR); Kia Corporation, Seoul (KR)

(72) Inventors: Hong Ki MIN, Hwaseong-Si (KR); Seungpyo JO, Hwaseong-Si (KR)

(21) Appl. No.: 19/273,580

(22) Filed: Jul. 18, 2025

(30) Foreign Application Priority Data
Feb. 3, 2025 (KR) 10-2025-0013113

(51) Int. Cl. B25J 9/16

(52) U.S. Cl. CPC B25J 9/1628

(57) ABSTRACT

The present disclosure relates to an apparatus and a method for controlling a robot. The apparatus of a robot may include: a processor; and a memory storing at least one instruction that is configured, when executed by the processor communicating with the memory, to cause the apparatus to: apply a random value to a first motion value associated with at least one first axis of movement among a plurality of axes of movement of the robot; apply an adjustment value to a second motion value associated with at least one second axis of movement, among the plurality of axes of movement of the robot, that is different from the at least one first axis of movement; and control, based on the first motion value and the second motion value, movement of the robot along each of the plurality of axes of movement of the robot.

### CROSS-REFERENCE TO RELATED APPLICATION

The present application claims priority to Korean Patent Application No. 10-2025-0013113, filed on Feb. 3, 2025, in the Korean Intellectual Property Office, the entire disclosure of which is incorporated herein by reference.

### FIELD

The present disclosure relates to an apparatus and method for controlling a robot.

### BACKGROUND

Robots are widely used in modern industry to perform various tasks. They generally have multiple axes of movement, and the motion of each axis may be precisely regulated through servo control. This servo control method plays an important role in ensuring the consistency and precision in a robot's operation.

In some implementations of robot control technology, each servo is controlled to generate a consistent output for a given position value. Therefore, the robot may maintain a consistent posture when operating in the same working position. This control method can be effective in working environments requiring precision. However, as tasks are repeated, the same load may be continuously and disproportionately applied to only some axes. As a result, intensive wear and fatigue may occur in specific areas, shortening the lifespan of robot components and becoming a major cause of increased maintenance costs.

In particular, servo motors and mechanical components of the robot may be at risk of damage due to such wear, which may lead to interruptions in the production process or a decline in product quality. Therefore, the limitations regarding wear and fatigue may need to be addressed without compromising task precision.

### SUMMARY

The present disclosure is directed to providing an apparatus and a method for controlling a robot to minimize wear and fatigue concentrated on specific axes or parts in a repetitive work environment.

In addition, the present disclosure is directed to providing an apparatus and a method for controlling a robot to extend the lifespan of robot components by introducing randomness into the motion of each axis while maintaining the task precision of the robot.

Further, the present disclosure is directed to an apparatus and a method for controlling a robot to extend the maintenance cycle of the robot, reduce operational costs, and achieve a stable and efficient work environment.

Aspects of the present disclosure are not limited to those mentioned above, and other aspects and advantages not mentioned above will be understood from the following description, and become more apparent from one or more example embodiments. Moreover, aspects of the present disclosure may be realized by the means and combinations thereof indicated in claims.

According to one or more example embodiments of the present disclosure, an apparatus of a robot may include a processor and a memory. The memory may store at least one instruction that is configured, when executed by the processor communicating with the memory, to cause the apparatus to: apply a random value to a first motion value associated with at least one first axis of movement among a plurality of axes of movement of the robot; apply an adjustment value to a second motion value associated with at least one second axis of movement, among the plurality of axes of movement of the robot, that is different from the at least one first axis of movement; and control, based on the first motion value and the second motion value, movement of the robot along each of the plurality of axes of movement of the robot.

The at least one instruction may be configured, when executed by the processor communicating with the memory, to cause the apparatus to apply the adjustment value by: determining the adjustment value via at least one of inverse kinematics or forward kinematics based on the first motion value.

The at least one instruction may be configured, when executed by the processor communicating with the memory, to cause the apparatus to control the movement of the robot by: returning, based on the robot failing to perform a predetermined task, the robot to a state prior to the application of the random value.

The at least one instruction may be configured, when executed by the processor communicating with the memory, to further cause the apparatus to, based on the robot failing to perform a predetermined task at a first time, exclude, at a second time later than the first time, the random value from being applied to a third motion value associated with the at least one first axis of movement of the robot.

The at least one instruction may be configured, when executed by the processor communicating with the memory, to further cause the apparatus to adjust, based on the robot failing to perform a predetermined task, a random number generation range associated with the at least one first axis of movement of the robot.

The at least one instruction may be configured, when executed by the processor communicating with the memory, to further cause the apparatus to generate the random value within a predetermined range.

The at least one instruction may be configured, when executed by the processor communicating with the memory, to further cause the apparatus to generate the random value based on a predetermined time cycle.

The at least one instruction may be configured, when executed by the processor communicating with the memory, to further cause the apparatus to determine a repetitive task associated with the robot. For different repetitions of the repetitive tasks, different random values may be generated for the first motion value associated with the at least one first axis of movement.

The apparatus may further include: a plurality of movable parts of the robot; and at least one link connecting the plurality of movable parts of the robot. The at least one link may be associated with a plurality of candidate movements for a repetitive task. The at least one instruction may be configured, when executed by the processor communicating with the memory, to cause the apparatus to control the movement of the robot by: for the repetitive task, controlling, based on the first motion value and the second motion value, movement associated with the at least one link along each of the plurality of axes of movement of the robot.

According to one or more example embodiments of the present disclosure, a method performed by an apparatus of a robot may include: applying, via a processor, a random value to a first motion value associated with at least one first axis of movement among a plurality of axes of movement of the robot; applying an adjustment value to a second motion value associated with at least one second axis of movement, among the plurality of axes of movement of the robot, that is different from the at least one first axis of movement; and controlling, based on the first motion value and the second motion value, movement of the robot along each of the plurality of axes of movement of the robot.

Applying the adjustment value may include determining the adjustment value via at least one of inverse kinematics or forward kinematics based on the first motion value.

Controlling the movement of the robot may include returning, based on the robot failing to perform a predetermined task, the robot to a state prior to the applying of the random value.

The method may further include, based on the robot failing to perform a predetermined task at a first time, excluding, at a second time later than the first time, the random value from being applied to a third motion value associated with the at least one first axis of movement of the robot.

The method may further include adjusting, based on the robot failing to perform a predetermined task, a random number generation range associated with the at least one first axis of movement of the robot.

The method may further include generating the random value within a predetermined range.

The method may further include generating the random value based on a predetermined time cycle.

The method may further include determining a repetitive task associated with the robot. For different repetitions of the repetitive tasks, different random values may be generated for the first motion value associated with the at least one first axis of movement.

The robot may further include: a plurality of movable parts of the robot; and at least one link connecting the plurality of movable parts of the robot. The at least one link may be associated with a plurality of candidate movements for a repetitive task. Controlling the movement of the robot may include: for the repetitive task, controlling, based on the first motion value and the second motion value, movement associated with the at least one link along each of the plurality of axes of movement of the robot.

According to one or more example embodiments of the present disclosure, a robot may include: a plurality of movable parts of the robot; and at least one link connecting the plurality of movable parts of the robot. The at least one link may be associated with a plurality of candidate movements for a repetitive task. The robot may further include a processor and a memory. The memory may store at least one instruction that is configured, when executed by the processor communicating with the memory, to cause the robot to: apply a random value to a first motion value associated with at least one first axis of movement among a plurality of axes of movement of the robot; apply an adjustment value to a second motion value associated with at least one second axis of movement, among the plurality of axes of movement of the robot, that is different from the at least one first axis of movement; and, for the repetitive task, control, based on the first motion value and the second motion value, movement associated with the at least one link along each of the plurality of axes of movement of the robot.

### BRIEF DESCRIPTION OF THE DRAWINGS

The foregoing and other aspects, features, and advantages, as well as the following detailed description of the example embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a diagram illustrating an apparatus for controlling a robot.

FIG. 2 is a flowchart illustrating a method for controlling a robot.

FIG. 3 is a diagram illustrating task execution of a welding robot having a plurality of axes.

FIG. 4 shows an example computing system.

### DETAILED DESCRIPTION

Hereinafter, one or more example embodiments disclosed in the present document will be described in detail with reference to the accompanying drawings. Like reference numerals designate like elements, and redundant descriptions thereof will be omitted. Further, such as “module” and a “unit”, suffixes for components used in the following description are given or mixed and used by considering easiness in preparing a specification and do not have a meaning or role distinguished from each other in themselves. In addition, in describing example embodiments disclosed in the present document, if it is determined that a detailed description of a related art incorporated herein unnecessarily obscure the gist of the example embodiments, the detailed description thereof may be omitted. Furthermore, it should be understood that the appended drawings are intended only to help understand example embodiments disclosed in the present document and do not limit the technical principles and scope of the present disclosure; rather, it should be understood that the appended drawings include all of the modifications, equivalents or substitutes described by the technical principles and belonging to the technical scope of the present disclosure.

Although the terms first, second, and the like, may be used herein to describe various elements, these elements should not be limited by these terms. These terms are generally only used to distinguish one element from another.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present.

Unless otherwise defined, the terms used herein, including technical or scientific terms, may have meanings generally understood by those skilled in the art to which the present disclosure belongs.

The expressions such as “comprise”, “may comprise”, “include”, “may include”, “have”, “may have”, etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip”, “second chip”, respectively.

The term “unit” as used herein may refer to software, or hardware component such as Field-Programmable Gate Array (FPGA), Application Specific Integrated Circuit (ASIC), etc. However, “unit” is not limited to hardware and software. The “unit” may be configured to be stored in an addressable storage medium, or may be configured to execute one or more processors. The “unit” may include components such as software components, object-oriented software components, class components, and task components, as well as processors, functions, attributes, procedures, subroutines, segments of program code, drivers, firmware, microcode, circuits, data, databases, data structures, tables, arrays, and variables.

The expression “based on” as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to”, “with the ability to”, “modified to”, “made to”, “to be able to”, etc. This expression is not limited to the meaning of “specially designed in hardware to”. For example, a processor configured to perform a specific operation may refer to a generic purpose processor capable of performing the specific operation by executing software, or to a special purpose computer structured through programming to perform the specific operation.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

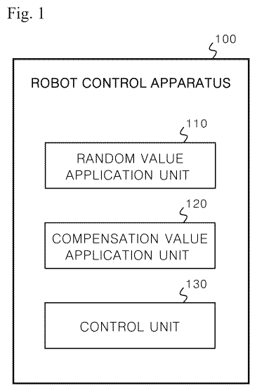

Hereinafter, an apparatus for controlling a robot and a method for controlling the robot according to the present disclosure will be described with reference to FIGS. 1 to 3 in detail.

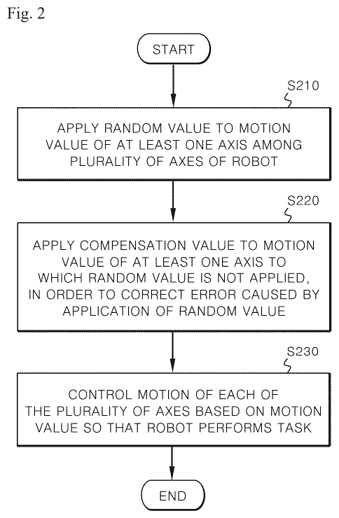

FIG. 1 is a block diagram illustrating a configuration of a robot control apparatus. FIG. 2 is a flowchart illustrating a method for controlling a robot.

Referring to FIG. 1, a robot control apparatus 100 may include a random value application unit 110, a compensation value application unit 120, a control unit 130, and the like. Some or all of the components shown in FIG. 1 may be implemented with, for example, hardware (e.g., one or more processors, software, or a combination of both.

The random value application unit 110 may be configured to apply a random value to a motion value of at least one axis of movement among a plurality of axes of movement of the robot (see S210 of FIG. 2).

For example, the robot may be a vertical articulated robot, a horizontal articulated robot, a Cartesian robot, a parallel robot, and/or a collaborative robot. The random value application unit 110 may be configured to add or subtract a random deviation for each axis rotation angle or Cartesian coordinate position to redistribute wear accumulated on one or more specific axes of the robot that repeatedly perform the same process over an extended period of time. As a result, a robot end effector may be guided (e.g., moved) so that it does not always move precisely to the same point (e.g., in the same manner) while maintaining task precision (e.g., without significant reduction in performance).

The random value application unit 110 may be configured to apply the random value within a predetermined range.

The random value application unit 110 may be configured, for example, to set a rotational angle range of approximately ±0.3 degrees to ±2 degrees or a linear coordinate range of approximately ±0.5 mm to ±5 mm, and apply a random value within the set range. Such a range may vary depending on physical constraints, including the stroke limit of the robot axis and the possibility of joint interference, as well as process precision requirements, such as the allowable position error range and the allowable angle error range. If, for example, the robot is tasked with assembling microelectronic components, the random value application unit 110 may be configured to set an extremely narrow generation range of random values to partially mitigate the repeated accumulation of localized wear in robot components without affecting task quality. In another example, if the robot is tasked with transporting general mechanical parts (e.g., that may not require a high level of precision), the random value application unit 110 may be configured to set a slightly broader generation range of random values and apply a random value to optimize the robot's lifespan and maintenance efficiency while ensuring that the task success rate is not significantly compromised.

The random value application unit 110 may be configured to set a broader generation range of the random value for processes with relatively large tolerance ranges, such as large welding robots. However, if keeping a low weld seam deviation is critical, the random value application unit 110 may be configured to apply a larger compensation value (e.g., adjustment value) to another axis, ensuring the final trajectory precision is maintained.

The random value application unit 110 may be configured to apply a random value based on a predetermined cycle (e.g., time cycle).

For example, the random value application unit 110 may be configured to generate a new random value based on a predetermined cycle (e.g., a time cycle or period), such as a work cycle or time unit, to ensure that randomness is evenly distributed throughout the robot operation process rather than being concentrated in specific sections. Specifically, the random value application unit 110 may be configured to adjust the cycle based on the work schedule, such as morning and afternoon shifts, or based on the time of day, such as daytime and nighttime. The random value application unit 110 may be configured to set a relatively broader range at nighttime to maximize the wear redistribution effect and a narrower range during the daytime to prioritize precision.

The compensation value application unit 120 may be configured to apply a compensation value (e.g., adjustment value) to a motion value of at least one axis to which the random value is not applied, in order to correct an error caused by the application of the random value (see S220 of FIG. 2).

For example, in a robot with a plurality of axes of movement, if a random deviation of ±0.5 degrees or more occurs in a specific axis, the position and/or posture of the end effector may slightly change, which may cause it to deviate from the target point. In this case, the compensation value application unit 120 may be configured to apply a correction angle, linear movement value, or the like to the other axes, thereby adjusting the end effector so that it accurately maintains the original target point or task trajectory.

The compensation value application unit 120 may be configured to determine the compensation value (e.g., adjustment value) through kinematic computation, including at least one of inverse kinematics or forward kinematics based on the motion value of the axis to which the random value is applied.

The compensation value application unit 120 may be configured to first check the motion value of the axis to which the random value is applied and then perform a kinematic computation, including at least one of inverse kinematics and forward kinematics, to derive an appropriate compensation value (e.g., adjustment value). For example, when the axis to which the random value is applied exhibits a deviation, such as +1.2 degrees, the compensation value application unit 120 may be configured to determine the effect of the deviation on the position or posture of the end effector using forward kinematics. Subsequently, the compensation value application unit 120 may be configured to determine the adjustments for the other axes to which the random value is not applied to correct the error occurring at the target point using inverse kinematics. Based on this determination, a new motion value specifying angular adjustments of ±a few degrees or linear displacements of ±a few millimeters may be applied to at least one axis of the other axes of movement, thereby minimizing the final error. During this computation process, the compensation value application unit 120 may be configured to comprehensively consider the robot's motion values, such as position, velocity, acceleration, and/or torque. Specifically, when handling heavy workpieces, the compensation value application unit 120 may be configured to set a limit range to prevent torque overload when applying the compensation value. In high-speed processes, to prevent an increase in cycle time due to excessive acceleration changes, the compensation value may be appropriately applied to at least one of the other axes.

The compensation value application unit 120 may be configured to iteratively apply inverse kinematics and forward kinematics computations to finely adjust the compensation value. When a large compensation value is applied to one axis, causing a risk of exceeding the safety limit angle of another axis, the compensation value application unit 120 may reduce the compensation value or distribute it across multiple axes for correction. In this way, even when a random value of approximately ±2 degrees is applied and a large compensation is required, the compensation value application unit 120 may ensure that the final end effector converges to the target trajectory without error. If ultra-high precision is required, as in medical surgical robots, even a random deviation, for example, of 0.2 degrees may cause a shift in the surgical site. Therefore, the compensation value application unit 120 may be configured to immediately determine the deviation through inverse kinematics and apply a precise angular adjustment to the other axes to ensure stable positioning of the surgical tool. If the working tolerance is relatively large, as in the case of a robotic system for assembling large aircraft components, deviations of approximately ±2 to ±3 degrees may be permissible. However, due to the heavy components and high joint loads, there is a high risk of exceeding torque limits. Therefore, the compensation value application unit 120 may perform a forward kinematics simulation to preemptively check for potential collisions and, if necessary, compensate for the posture using additional axes as an operational strategy.

The compensation value application unit 120 may be configured to recognize changes in the axes caused by the application of random values and flexibly compensate for them through kinematic computation, ensuring that the end effector continues to meet the required process precision. By doing so, the compensation value application unit 120 suppresses localized wear due to repetitive operations along the same trajectory of the robot while maintaining task stability and production efficiency.

The compensation value application unit 120 may be configured to work in conjunction with machine learning or online adaptive control techniques, accumulating axis deviation patterns as training data and optimizing the compensation patterns for each axis.

The control unit 130 may be configured to control the motion of each of the plurality of axes based on a motion value (also referred to as a movement value or a movement amount) so that the robot performs a task (see S230 of FIG. 2).

For example, the control unit 130 may be configured to cause the robot to perform a required task, such as component assembly, component transfer, welding, painting, or inspection, based on the motion value corresponding to each axis. In this context, the motion value refers to various types of information related to the movement of the robot axes, including position information such as the rotation angle of each axis, linear movement distance, and coordinate values of the end effector, as well as speed, acceleration, and torque information.

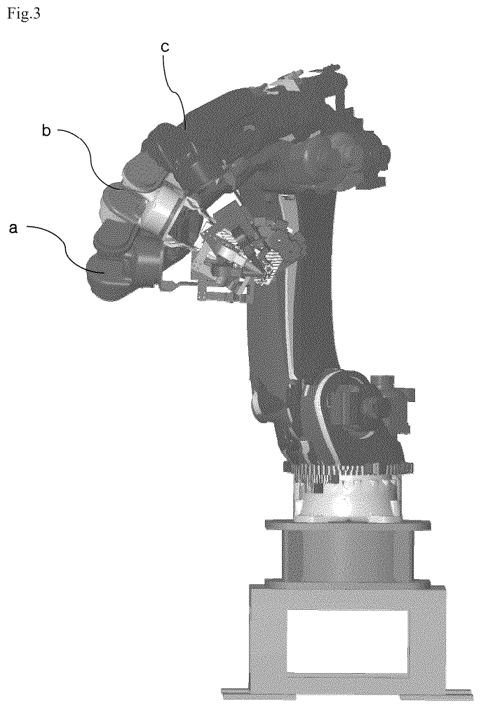

FIG. 3 is a diagram illustrating the task execution of a welding robot having a plurality of axes.

Referring to FIG. 3, a random value is applied to a motion value of the axis associated with the end of a welding arm, causing variations in the motion of each robot axis. Due to the application of such random values, the overall motion of the robot may vary, as seen in a, b, and c. However, it may be observed that the same task is repeatedly performed in a key region. Through this approach, the welding robot may randomly vary the motion of a specific axis within a certain range, thereby redistributing wear at a specific position and facilitating efficient maintenance of the equipment.

The control unit 130 may restore the robot to its previous state when the robot fails to perform the task properly while using the applied random values.

For example, when an unexpected collision or over-torque is detected due to the applied random values, the control unit 130 may immediately stop the operation, switch to safety mode, and then return the respective robot axes to the last normal position, initial safe position, or another designated position to prevent damage to the equipment and ensure process continuity. Subsequently, the control unit 130 may store an error log, the random values applied at the time, the position information of each axis, the torque information, and other relevant data after returning.

The random value application unit 110 may exclude random values that caused task failure from future processes (e.g., after the robot fails to perform a task).

For example, when random values within a certain range repeatedly cause defects or collisions, the random value application unit 110 may record them as error values and adjust a random value generation algorithm to prevent the same or similar deviations from being generated in the future. The random value application unit 110 may analyze factors such as count limits and acquired error patterns, including the position of each axis, acceleration, and center of mass, to refine and filter out problematic values that occur only in specific axis combinations.

The random value application unit 110 may adjust a generation range of the random value associated with task failure.

For example, when the random value application unit 110 analyzes long-term operation history and obtains statistics indicating that the frequency of collisions significantly increases at an angular deviation exceeding ±2 degrees, it may subsequently limit a generation range of the random value to ±1.5 degrees or allocate larger random values to axes with smaller loads. This maintains the overall wear redistribution effect while reducing the task failure rate. In contrast, when the random value application unit 110 identifies a process section where sufficient process margin is ensured and stable execution is maintained, it may expand the allowable deviation range by approximately ±3 degrees to diversify the movement of each axis. The random value application unit 110 may apply range expansion or reduction based on robot conditions such as joint wear, motor temperature, and operation time, as well as process requirements such as precision and delivery schedule. When necessary, it may also adopt a strategy of incorporating machine learning-based optimization techniques to update the most appropriate random value distribution in real time.

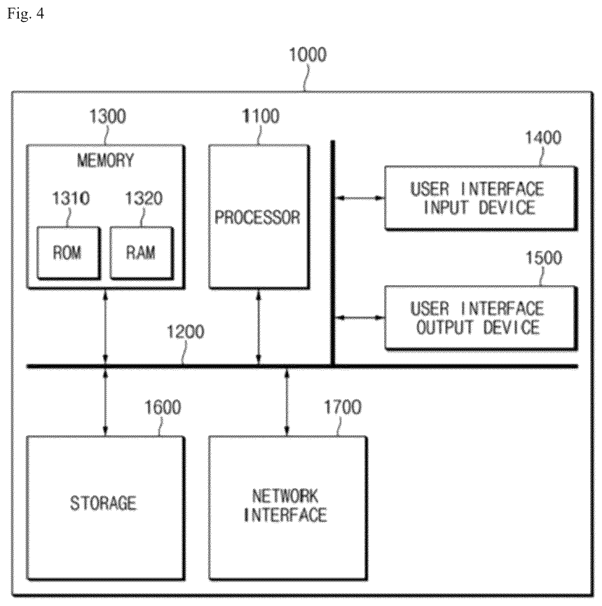

FIG. 4 shows an example computing system (e.g., a computing device of a vehicle or any other apparatus). One or more controllers, processors, etc. described herein, such as the robot control apparatus 100, the random value application unit 110, the compensation value application unit 120, and/or the control unit 130, may be implemented by the computing system or may be implemented in the computing system.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (i.e., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

An aspect of the present disclosure provides an apparatus for controlling a robot, the apparatus including a random value application unit configured to apply a random value to a motion value of at least one axis among a plurality of axes of the robot, a compensation value application unit configured to apply a compensation value to a motion value of at least one axis to which the random value is not applied, in order to correct an error caused by the application of the random value, and a control unit configured to control a motion of each of the plurality of axes based on the motion value so that the robot performs a task.

The compensation value application unit may be configured to determine the compensation value through kinematic computation, including at least one of inverse kinematics or forward kinematics, based on the motion value of the axis to which the random value is applied.

Another aspect of the present disclosure provides a method for controlling a robot, the method including applying a random value to a motion value of at least one axis among a plurality of axes of the robot, applying a compensation value to a motion value of at least one axis to which the random value is not applied, in order to correct an error caused by the application of the random value, and controlling a motion of each of the plurality of axes based on the motion value so that the robot performs a task.

The applying the compensation value may include determining the compensation value through kinematic computation, including at least one of inverse kinematics or forward kinematics based on the motion value of the axis to which the random value is applied.

According to the present disclosure, wear and fatigue concentrated on specific axes or parts in a repetitive work environment may be minimized.

In addition, according to the present disclosure, the lifespan of robot components may be extended by introducing randomness into the motion of each axis while maintaining the task precision of the robot.

Further, according to the present disclosure, the maintenance cycle of the robot may be extended, operational costs may be reduced, and a stable and efficient work environment may be achieved.

As used in the present disclosure, the terms “a/an” and “the” include both singular and plural references, unless the context clearly states otherwise. Also, it should be understood that any numerical range recited in the present disclosure is intended to include all sub-ranges subsumed therein (unless expressly indicated otherwise) and accordingly, the disclosed numeral ranges include every individual value between the minimum and maximum values of the numeral ranges.

The steps constituting the method according to the present disclosure may be performed in an appropriate order unless a specific order is described or otherwise specified. That is, the present disclosure is not necessarily limited to the order in which the steps are recited. All examples described in the present disclosure or the terms indicative thereof (“for example”, “such as”) are merely to describe the present disclosure in greater detail. Therefore, it should be understood that the scope of the present disclosure is not limited to the example embodiments described above or by the use of such terms unless limited by the appended claims. Also, it should be apparent to those skilled in the art that various modifications, combinations, and alternations may be made depending on design conditions and factors within the scope of the appended claims or equivalents thereof.

The present disclosure is thus not limited to the example embodiments described above, and rather intended to include the following appended claims, and all modifications, equivalents, and alternatives falling within the spirit and scope of the following claims.

What is claimed is:

1. An apparatus of a robot, the apparatus comprising:
a processor; and
a memory storing at least one instruction that is configured, when executed by the processor communicating with the memory, to cause the apparatus to:
apply a random value to a first motion value associated with at least one first axis of movement among a plurality of axes of movement of the robot;
apply an adjustment value to a second motion value associated with at least one second axis of movement, among the plurality of axes of movement of the robot, that is different from the at least one first axis of movement; and
control, based on the first motion value and the second motion value, movement of the robot along each of the plurality of axes of movement of the robot.

2. The apparatus according to claim 1, wherein the at least one instruction is configured, when executed by the processor communicating with the memory, to cause the apparatus to apply the adjustment value by:
determining the adjustment value via at least one of inverse kinematics or forward kinematics based on the first motion value.

3. The apparatus according to claim 1, wherein the at least one instruction is configured, when executed by the processor communicating with the memory, to cause the apparatus to control the movement of the robot by:
returning, based on the robot failing to perform a predetermined task, the robot to a state prior to the application of the random value.

4. The apparatus according to claim 1, wherein the at least one instruction is configured, when executed by the processor communicating with the memory, to further cause the apparatus to, based on the robot failing to perform a predetermined task at a first time, exclude, at a second time later than the first time, the random value from being applied to a third motion value associated with the at least one first axis of movement of the robot.

5. The apparatus according to claim 1, wherein the at least one instruction is configured, when executed by the processor communicating with the memory, to further cause the apparatus to adjust, based on the robot failing to perform a predetermined task, a random number generation range associated with the at least one first axis of movement of the robot.

6. The apparatus according to claim 1, wherein the at least one instruction is configured, when executed by the processor communicating with the memory, to further cause the apparatus to generate the random value within a predetermined range.

7. The apparatus according to claim 1, wherein the at least one instruction is configured, when executed by the processor communicating with the memory, to further cause the apparatus to generate the random value based on a predetermined time cycle.

8. The apparatus according to claim 1, wherein the at least one instruction is configured, when executed by the processor communicating with the memory, to further cause the apparatus to determine a repetitive task associated with the robot, wherein, for different repetitions of the repetitive tasks, different random values are generated for the first motion value associated with the at least one first axis of movement.

9. The apparatus according to claim 1, wherein the apparatus further comprises:
a plurality of movable parts of the robot; and
at least one link connecting the plurality of movable parts of the robot, wherein the at least one link is associated with a plurality of candidate movements for a repetitive task, and
wherein the at least one instruction is configured, when executed by the processor communicating with the memory, to cause the apparatus to control the movement of the robot by:
for the repetitive task, controlling, based on the first motion value and the second motion value, movement associated with the at least one link along each of the plurality of axes of movement of the robot.

10. A method performed by an apparatus of a robot, the method comprising:
applying, via a processor, a random value to a first motion value associated with at least one first axis of movement among a plurality of axes of movement of the robot;
applying an adjustment value to a second motion value associated with at least one second axis of movement, among the plurality of axes of movement of the robot, that is different from the at least one first axis of movement; and
controlling, based on the first motion value and the second motion value, movement of the robot along each of the plurality of axes of movement of the robot.

11. The method according to claim 10, wherein the applying of the adjustment value comprises determining the adjustment value via at least one of inverse kinematics or forward kinematics based on the first motion value.

12. The method according to claim 10, wherein the controlling of the movement of the robot comprises returning, based on the robot failing to perform a predetermined task, the robot to a state prior to the applying of the random value.

13. The method according to claim 10, further comprising, based on the robot failing to perform a predetermined task at a first time, excluding, at a second time later than the first time, the random value from being applied to a third motion value associated with the at least one first axis of movement of the robot.

14. The method according to claim 10, further comprising adjusting, based on the robot failing to perform a predetermined task, a random number generation range associated with the at least one first axis of movement of the robot.

15. The method according to claim 10, further comprising generating the random value within a predetermined range.

16. The method according to claim 10, further comprising generating the random value based on a predetermined time cycle.

17. The method according to claim 10, further comprising determining a repetitive task associated with the robot, wherein, for different repetitions of the repetitive tasks, different random values are generated for the first motion value associated with the at least one first axis of movement.

18. The method according to claim 10, wherein the robot further comprises:
a plurality of movable parts of the robot; and
at least one link connecting the plurality of movable parts of the robot, wherein the at least one link is associated with a plurality of candidate movements for a repetitive task, and
wherein the controlling the movement of the robot comprises:
for the repetitive task, controlling, based on the first motion value and the second motion value, movement associated with the at least one link along each of the plurality of axes of movement of the robot.

19. A robot comprising:
a plurality of movable parts of the robot;
at least one link connecting the plurality of movable parts of the robot, wherein the at least one link is associated with a plurality of candidate movements for a repetitive task;
a processor; and
a memory storing at least one instruction that is configured, when executed by the processor communicating with the memory, to cause the robot to:
apply a random value to a first motion value associated with at least one first axis of movement among a plurality of axes of movement of the robot;
apply an adjustment value to a second motion value associated with at least one second axis of movement, among the plurality of axes of movement of the robot, that is different from the at least one first axis of movement; and
for the repetitive task, control, based on the first motion value and the second motion value, movement associated with the at least one link along each of the plurality of axes of movement of the robot.
